(19) United States
(12) Patent Application Publication
(10) Pub. No.: US 2004/0072558 A1
(43) Pub. Date: Apr. 15, 2004

(54) System and method of forwarding an incoming call to a vehicle's embedded transceiver

(76) Inventor: James A. Van Bosch, Crystal Lake, IL (US)

Correspondence Address: MOTOROLA, INC., 1303 EAST ALGONQUIN ROAD, IL01/3RD, SCHAUMBURG, IL, 60196

(21) Appl. No.: 10/271,292

(22) Filed: Oct. 15, 2002

(51) Int. Cl. H04Q 7/00

(52) U.S. Cl. 455/417

(57) ABSTRACT

A system and method in a portable wireless communication device (22) for forwarding incoming calls, originally directed to the portable wireless communication device, to a vehicle transceiver (64) in a vehicle (20). The system in the device (22) comprises a cellular transceiver (42), at least one external interface (28A, 28B, 28C), and a microcomputer (40). The external interface (28A, 28B, 28C) may be for wired or wireless connections to the vehicle (20). The microcomputer (40) is connected to the external interface (28A, 28B, 28C) and is programmed to forward any incoming calls to the vehicle transceiver (64) when it is determined that the portable wireless communication device (22) is connected to the vehicle (20).

### FIELD OF THE INVENTION

This invention in general relates to hands-free cellular communication systems for vehicles and, more particularly, to a system and method of forwarding calls to a vehicle's embedded transceiver when a user enters the vehicle with a separate portable wireless communication device.

### BACKGROUND OF THE INVENTION

Today, many people use portable wireless communication devices in their vehicles. For safety reasons, the industry is focused on providing hands-free features to people who use portable devices in their vehicle. There is a need for more efficient wireless communications when a user is sitting in a vehicle that contains both a portable wireless communication device and a separate embedded transceiver.

For instance, several types of hands-free systems in a vehicle include an embedded transceiver to transmit and receive audio and data through a wireless communication protocol. These systems provide hands-free personal communications through an embedded microphone and speaker in the vehicle. The OnStar® system by General Motors is an example of such a hands-free system. An outside party may establish a wireless communication link with the vehicle by dialing a phone number associated with the vehicle's embedded transceiver.

A problem exists today when a user of a hands-free system (with an embedded transceiver) also owns a separate portable or handheld wireless communication device. The handheld wireless communication device has a dialing number that is different from the one required for establishing contact with the vehicle's embedded transceiver. This may cause confusion to a user or a third party trying to place a call to the user. For example, the user may need to inform the third party caller to re-dial a different number to reach the vehicle's embedded transceiver if the user is in the vehicle and wishes to use the hands-free system.

A temporary work around is for the user to manually enter a series of commands on the handheld wireless communication device to forward calls to the vehicle's embedded transceiver. This manual configuration, however, must be done each time the user enters and leaves the vehicle. For instance, many handheld phones require a user to type in an access code and then the forwarding telephone number to set up call forwarding. To end call forwarding, the user must enter another access code. Knowledge of the vehicle's embedded transceiver may also be necessary. The method used today is cumbersome and, in some cases, may actually defeat the purpose of hands-free systems—to reduce distractions. Accordingly, it would be beneficial to eliminate the manual operation of forwarding calls. It would also be beneficial to make such a system compatible to different vehicles having different embedded transceivers.

It is, therefore, desirable to provide an improved hands-free cellular communication system and method for dynamically configuring a portable wireless communication device to overcome or minimize most, if not all, of the preceding problems.

### BRIEF DESCRIPTION OF THE DRAWINGS

FIG. 1 is a perspective view of a portable wireless communication device and a hands-free control unit in a vehicle according to one embodiment of the present invention;

FIG. 2 is a perspective view of a portable wireless communication device and a hands-free control unit in a vehicle according to another embodiment of the present invention;

FIG. 3 is a block diagram of a portable wireless communication device connected to a vehicle according to one embodiment of the present invention;

FIG. 4 is a perspective view of a portable wireless communication device and a hands-free control unit in a vehicle according to another embodiment of the present invention;

FIG. 5 is a block diagram of a portable wireless communication device wirelessly connected to a vehicle according to another embodiment of the present invention; and

FIG. 6 is a message flow diagram of one embodiment to forward incoming calls, originally directed to a portable wireless communication device, to a vehicle's embedded transceiver.

FIG. 7 is a flow diagram of one method to forward incoming calls, originally directed to a portable wireless communication device, to a vehicle's embedded transceiver.

FIG. 8 is a flow diagram of another method to forward incoming calls, originally directed to a portable wireless communication device, to a vehicle's embedded transceiver.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the appended claims.

### DETAILED DESCRIPTION

What is described is a system and method of forwarding calls to a vehicle's embedded transceiver when a user enters the vehicle with a separate portable wireless communication device. As used herein, the call may include voice or data. The system and method reduces the complexity and the number of distractions in setting up and using an existing hands-free system. The system and method is also designed to be compatible with different types of vehicles and hands-free systems.

To this end, in one embodiment, there is a portable wireless communication device comprising a cellular transceiver and a microcomputer. The microcomputer has a detector to determine whether the portable wireless communication device is connected to a vehicle. The microcomputer is programmed to forward an incoming call, originally directed to the portable wireless communication device, to a vehicle transceiver within the vehicle when the detector determines that the portable wireless communication device is connected to the vehicle. In one embodiment, the call forwarding may be set up by having the device send a message to a network associated with the portable wireless communication device that includes a phone number for establishing a wireless communication link with the vehicle transceiver.

The portable wireless communication device may further include an external interface. The interface may be an external interface used for a wired or a wireless communication with the vehicle. The external interface in this invention can be used to inform the portable wireless communication device that the user has connected the device to a vehicle and that the device should forward any incoming calls to the vehicle's embedded transceiver. The detector is capable of monitoring the external interface to determine whether the external interface is connected to the vehicle. In one embodiment, the external interface may be connected to an external cord that extends between the portable wireless communication device and the vehicle. The external cord includes at least one communication line that is used by the portable wireless communication device to determine whether it has been attached to the vehicle. For instance, the communication line (in the external cord) may be grounded when connected to the vehicle. This would then be an indicator to the portable wireless communication device that the device is connected to the vehicle.

In another embodiment, the external interface may be for attaching the portable wireless communication device to a device docking station mounted in the vehicle. The external interface may be a mechanical switch that is activated when the portable wireless communication device is placed in the docking station. Alternatively, the external interface could be an electrical interface for a communication line at the docking station. The portable wireless communication device monitors the external interface and when the interface is connected to the communication line it would then determine that the device is connected to the vehicle. The communication line could be simply grounded or, alternatively, be wired to a hands-free control unit in the vehicle. If wired to a hands-free control unit in the vehicle, the communication line may be used by the portable wireless communication device to receive data or other information about how to establish a communication link with the vehicle's embedded transceiver.

In a further embodiment, the external interface may be a short-range transceiver. The detector is capable of monitoring the short-range transceiver to detect a wireless connection to the vehicle. The vehicle connection could be triggered upon an event that would indicate that the user is in the vehicle, such as starting the ignition or a user input button. The short-range transceiver could also have a limited predetermined range of establishing a connection with the vehicle to ensure that the device is within the vehicle. The wireless connection may also be used to obtain data or other information regarding the use of the vehicle's embedded transceiver.

There is also described a system for forwarding incoming calls, originally directed to a portable wireless communication device, to a vehicle transceiver in a vehicle. The system comprises a cellular transceiver, an external interface, and a microcomputer. The external interface is for connecting to the vehicle. The microcomputer is connected to the external interface and is programmed to forward any incoming calls to the vehicle transceiver when it is determined that the portable wireless communication device is connected to the vehicle.

There is also a method in a portable wireless communication device that includes the steps of: determining whether the portable wireless communication device is connected to a vehicle; and sending a message to a network associated with the portable wireless communication device when it is determined that the portable wireless communication device is connected to the vehicle, the message containing data to forward incoming calls, originally directed to the portable wireless communication device, to a transceiver in the vehicle. The method may further include the steps of: determining whether the portable wireless communication device becomes disconnected to the vehicle; and sending a second message to the network associated with the portable wireless communication device when it is determined that the portable wireless communication device becomes disconnected to the vehicle, the second message containing data to cancel the forwarding of incoming calls.

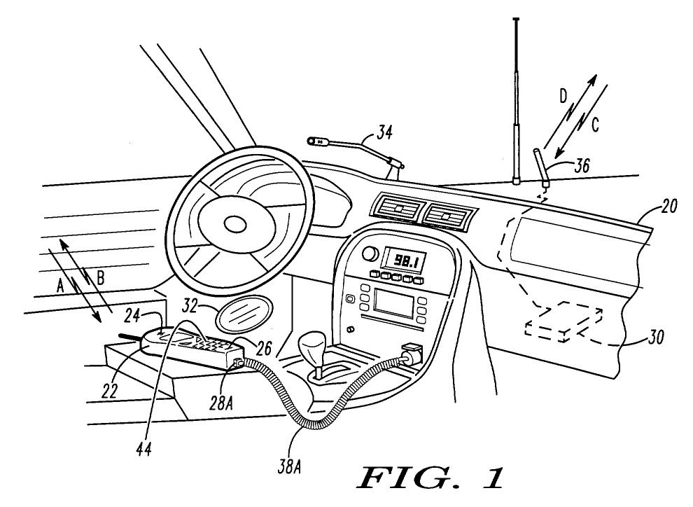

Now, turning to the drawings, FIGS. 1, 2, and 4 are perspective views of the cabin of a vehicle 20. Within the cabin of the vehicle 20 is a portable wireless communication device 22. The portable wireless communication device 22 shown in these figures include a handheld wireless phone that includes a transceiver that allows a user to establish a wireless voice communication through the device's internal speaker 24 and internal microphone 26. A remote third party (not shown) who desires to establish a wireless communication link with the wireless communication device 22 dials a specific number associated with the wireless communication device 22. A wireless network (not shown) associated with the portable wireless communication device 22 routes the incoming call from the remote third party to the device. When a wireless communication link is eventually established, the portable wireless communication device 22 may then receive downlink and transmit uplink wireless communications A and B.

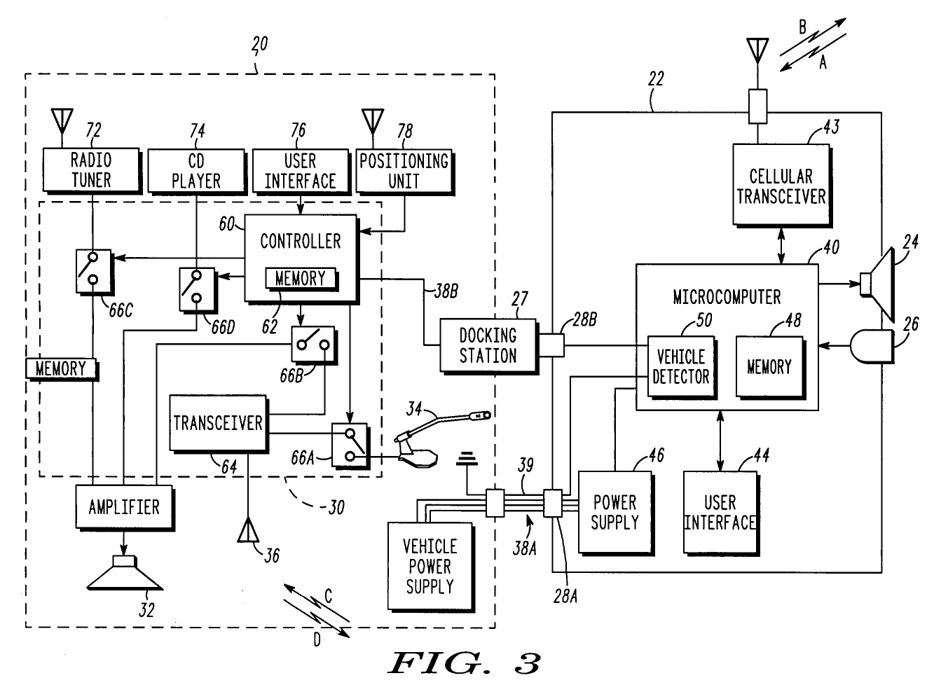

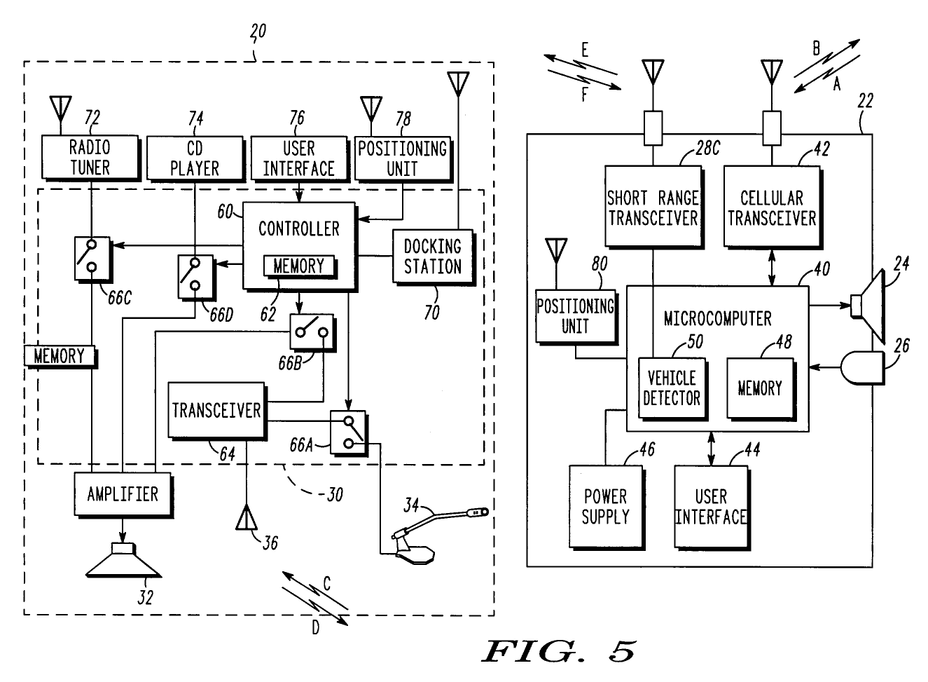

The vehicle 20 illustrated in FIGS. 1, 2 and 4 also has an embedded hands-free control unit 30. Here, the hands-free control unit 30 includes a separate transceiver 64 (see FIGS. 3 and 5) that allows the user to establish a wireless voice communication through the audio system (including an audio speaker 32 and an audio microphone 34) in the vehicle 20. The hands-free control unit 30 may receive downlink and transmit uplink wireless communications C and D through an external antenna 36 of the vehicle 20. A remote third party (not shown) who desires to establish a wireless communication link with the hands-free control unit 30 dials a specific number associated with the vehicle's embedded transceiver.

A user will typically desire using the vehicle's hands-free communication system when sitting in the cabin of the vehicle 20. This may pose a problem, however, when a third party attempts to establish a wireless communication link with the user through the user's wireless communication device 22. This may happen when the third party caller does not know the specific number associated with the vehicle's embedded transceiver. This may also happen when the third party caller does not know that the user of the wireless communication device 22 is sitting within the cabin of the vehicle.

In one embodiment of the present invention, the portable wireless communication device 22 has a mechanism for detecting whether the device 22 is connected to the vehicle 20. If the portable wireless communication device 22 is connected to the vehicle 20, then the device 22 may then be configured or otherwise programmed to automatically send a message to a wireless network associated with the device 22 and insist that all subsequent incoming calls be forwarded to a vehicle's embedded transceiver 64. When the portable wireless communication device 22 determines that it has been disconnected with the vehicle 20, the device 22 may then be configured or otherwise programmed to automatically send a second message to the wireless network associated with the device 22 to cancel the forwarding of incoming calls. As will be explained and taught below, this configuration is set up automatically to reduce distractions and complexity to the user.

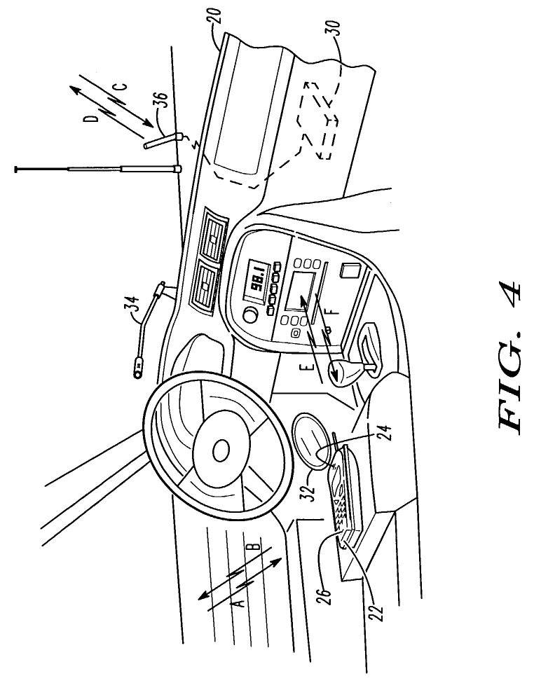

In one embodiment, the portable wireless communication device 22 has at least one external interface 28A, 28B, 28C that is capable of being connected to the vehicle 20. The embodiment shown in FIGS. 1-3 illustrate systems with interfaces for wired connections. The present invention may also include interfaces for wireless connections as will be discussed in the context of FIGS. 4 and 5. Turning initially to FIG. 1, however, a wired type external interface may be an external interface 28A that is configured for connecting to an external cord 38A. The external cord 38A has connectors to establish a connection between the portable wireless communication device 22 and the vehicle 20. A user of the portable wireless communication device 22 may use a DC power interface in the vehicle 20 to recharge the battery in the device 22. Accordingly, in one embodiment, the present invention uses this interface to detect whether the portable wireless communication device 22 is connected to the vehicle 20. To distinguish an external cord 38A for a vehicle from a non-vehicle external cord, the external cord 38A may include at least one communication line that is used by the portable wireless communication device 22 to determine whether it has been attached to the vehicle 20. For instance, the communication line (within the external cord) may be configured so that it is grounded when connected to the vehicle 20. This would indicate to the device 20 that the external cord 38A is connected to the vehicle 20.

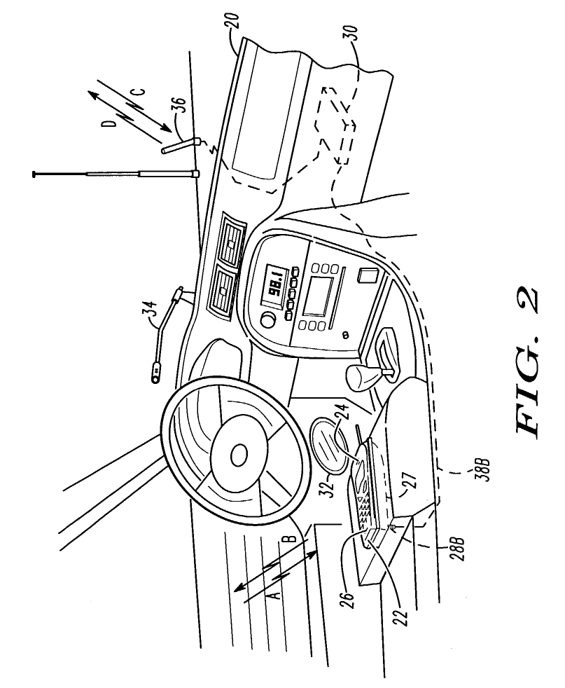

In another embodiment, as shown in FIG. 2, an external interface 38B could be capable of connecting to a device docking station 27 that is mounted in the vehicle 20. The external interface 38B could be a mechanical switch that is activated when the portable wireless communication device 22 is placed in the docking station 27. Alternatively, the external interface 38B could be an electrical interface at the docking station 27 for connecting to the hands-free control unit 30 in the vehicle 20. For instance, as shown in FIG. 2, the device docking station 27 could be connected to the hands-free control unit 30 in the vehicle 20 via an internal cord 38B. The portable wireless communication device 22 could connect to the docking station 27 and internal cord 38B through its external interface 38B.

The interaction between the portable wireless communication device 22 and the vehicle 20 will now be explained in the context of FIG. 3. FIG. 3 illustrates a portable wireless communication device 22 in the form of a cellular phone capable of receiving downlink and transmitting uplink cellular voice communications A and B. In this embodiment, the portable wireless communication device 22 may include a speaker 24, a microphone 26, at least one external interface 28A, 28B, a microcomputer 40, a cellular transceiver 42, a user interface 44, and a power supply 46. The portable wireless communication device 22 may further include other circuitry for interconnecting various components within the device.

As will be explained in more detail below, prior to or during call set-up, the portable wireless communication device 22 includes a vehicle detector 50 for determining whether the device is connected to a vehicle 20. In one embodiment, the vehicle detector 50 is implemented in the microcomputer 40 to determine whether any of the external interfaces 28A, 28B are connected to the vehicle 20. If so, then it may be determined that the device 22 is in the cabin of the vehicle 20 and any incoming calls should be forwarded to an embedded transceiver 64 in the vehicle 20.

In one embodiment, the vehicle detector 50 may include a circuit that monitors whether one of the external interfaces 28A, 28B has been connected to the vehicle 20. For instance, the vehicle detector 50 may include a circuit that monitors the external interfaces 28A to see if a communication line 39 in the external cord 38A is connected to the vehicle 20. The system could be configured so that the communication line 39 in the external cord 38A is grounded when connected to the vehicle 20. This could be used by the portable wireless communication device 22 as an indicator that the device 22 is attached to a component of the vehicle and, thereby, conclude that the device 22 is in the cabin of the vehicle 20. A similar circuit and communication line could be used for the monitoring of the external interface 28B in the docking station 27.

The microcomputer 40 in the portable wireless communication device 22 has memory 48 for storing operating software and variables that may be used in accordance with the present invention. For instance, the memory 48 may contain a monitoring program for instructing the processor to cooperate with the external interfaces 28A, 28B and discover whether either one of the interfaces is connected to the vehicle 20.

Once it is determined that that the portable wireless communication device 22 is connected to the vehicle 20, the microcomputer 40 may be programmed to forward an incoming call to the vehicle's embedded transceiver 64. Preferably, once a connection is detected, the microcomputer 40 will forward all subsequent incoming calls, originally directed to the portable wireless communication device 22, to the vehicle transceiver 64. This may be accomplished, in one embodiment, by sending a message to the wireless network associated with the device 22. The message would include an instruction to forward incoming calls as well as the phone number associated with the vehicle transceiver 64.

The phone number associated with establishing a wireless communication with the vehicle transceiver 64 may be obtained by the portable wireless communication device 22 in a number of ways. For instance, if there is a communication connection between the portable wireless communication device 22 and the hands-free control unit 20 (such as the internal cord 38B), the portable wireless communication device could use the connection to obtain information or other data from the vehicle 20. The vehicle information may include whether the vehicle 20 has an operable separate embedded cellular transceiver 64 and data regarding the operation of the vehicle's embedded cellular transceiver 64. The data regarding the operation could include the phone number associated with the vehicle's embedded cellular transceiver 64 to establish a wireless communication link. The portable wireless communication device 22 could then use the phone number to automatically notify the cellular network to forward an incoming call to the number associated with the vehicle's embedded cellular transceiver 64. The vehicle's embedded cellular transceiver 64 would then be capable of receiving and transmitting cellular communications through the radio system (including an audio speaker 32 and a microphone 34) in the vehicle 20. In this way, the portable wireless communication device 22 may be set up to interface with different types of hands-free systems.

The portable wireless communication device 22 may also obtain the number associated with establishing a wireless communication link with the vehicle transceiver 64 by retrieving that information from its own memory 48. The information in memory 48 could be stored during a previous exchange of information between the vehicle 20 and the portable wireless communication device 22 through a communication line in the internal cord 38B. Alternatively, the information in memory 48 could be stored during a previous entry of information by the user through the user interface 44.

Generally, the hands-free control unit 30 may include a controller 60, a transceiver 64, and a plurality of switches 66A, 66B, 66C, 66D or other circuitry logic. Referring to the embodiment illustrated in FIG. 3, the controller 60 may be connected to a switch 66A to provide the ability to switch, transfer, or otherwise route the audio for uplink wireless communications B from the vehicle microphone 34 to the vehicle's embedded transceiver 64. The controller 60 may be further connected to a switch 66B to provide the ability to switch, transfer, or otherwise route the audio of downlink wireless communications A from the vehicle's embedded transceiver 64 to the vehicle speakers 32.

The hands-free control unit 30 may further be connected to peripheral input devices of the radio system of the vehicle 20 such as a radio tuner 72 and a CD player 74 through switches 66C, 66D. This allows the hands-free control unit 30 to mute the input devices during a phone conversation over the radio system. The hands-free control unit 30 may also be connected to a user interface 76 to receive information such as whether to initiate a call set-up. The control unit may further be connected to a positioning unit 78 to provide positioning information regarding the location of the vehicle 20.

As mentioned above, the portable wireless communication device 22 could be programmed and configured to detect whether the device is connected to the vehicle and then automatically forward all subsequent incoming calls to the vehicle transceiver 64. This may be accomplished by sending a message to a wireless network associated with the device 22 and insist that all subsequent incoming calls be forwarded to the vehicle's embedded transceiver 64. This would end when the portable wireless communication device 22 sends a second message after it is detected that the device 22 has been disconnected from the vehicle 20.

In an alternative embodiment, the portable wireless communication device 22 could be configured to wait until an incoming call is being attempted before forwarding the call. For instance, in one embodiment where there is a communication link between the vehicle 20 and the device 22, a switch on the user interface 76 of the vehicle is capable of initiating an activation signal or other indicator to the portable wireless communication device 22. In response to receiving a signal from the switch, the hands-free control unit 30 would then be capable of sending an activation signal or other indicator to the portable wireless communication device 22. In one embodiment, the activation signal or indicator to the wireless communication device 22 can be done by temporarily grounding a communication line in the internal cord 38B. The portable wireless communication device 22 would have the capability of detecting the temporary ground in the line through the vehicle detector 50. This would inform the portable wireless communication device 22 that the user would like to accept an incoming call but that the call should go through the hands-free system in the vehicle 20.

In such a case, the microcomputer 40 within the device 22 is configured according to known methods to monitor the cellular transceiver 50 for pending incoming cellular voice communications. Upon receiving a pending voice communication, the microcomputer 40 may notify the operator of a pending voice communication via an audio alert. The microcomputer 40 would then determine whether the vehicle operator agrees to accept the voice communication. In one embodiment, the microcomputer 50 may make this determination by waiting for a predetermined time period to detect whether the hands-free control unit 30 transmits an activation signal or other indicator. In an alternative embodiment, the microcomputer 40 may make this determination by waiting for a predetermined period to detect whether the user has selected a button on the user interface 44 of the portable wireless communication device 22. If the pending incoming voice communication is not accepted, then the microcomputer 40 can do nothing and let the voice communication transfer to an electronic voice answering service. Alternatively, the microcomputer 40 can respond to the voice communication by sending a special message to the incoming caller that the operator of the vehicle is not able to respond to the call at this time.

If the microcomputer 40 determines that the pending incoming voice communication is accepted (an activation signal or other indicator has been detected or received), then the microcomputer 40 would need to determine whether the portable wireless communication device 22 is connected to the vehicle 20. This may be accomplished through the use of a monitoring program such as the vehicle detector 50. Once it is determined that the device 22 is connected to the vehicle 20, then the device 22 needs to set up the call by forwarding the incoming attempted call to the vehicle transceiver 64. The microcomputer 40 may forward the incoming attempted call to the vehicle transceiver 64 based on information obtained from the vehicle 20 or accessed from its own memory 48.

In one embodiment of the present invention, the hands-free control unit 30 may transfer vehicle information to the portable wireless communication device 22 at the time the device is plugged into the vehicle 20. The received vehicle information may be stored in memory 48 of the portable wireless communication device 22. The stored vehicle information would then be made available to the device at the time of call setup (or sooner) for purposes of configuring the device. In another embodiment, the portable wireless communication device 22 accesses the vehicle information from the vehicle 20 at or during the time of call setup. In this case, the vehicle information is stored in memory 62 of the controller 60 and accessed after it is determined that the internal cord 28B is connected to the vehicle 20. In a further embodiment, the portable wireless communication device 22 accesses its own memory 44 having a database that stores information regarding different types of vehicles and hands-free systems. The portable wireless communication device 22 determines the type of vehicle and hands-free system and then access vehicle information stored in the database.

The vehicle information may contain information on whether the vehicle 20 has a separate cellular transceiver 64 in the vehicle 20 and data associated with the operation of the cellular transceiver 64. The data associated with the operation of the transceiver 64 may include a phone number to establish a wireless communication link with the transceiver 64. Here, the wireless communication device 22 could use the data to forward incoming calls to the phone number specified in data.

FIGS. 1-3 illustrate embodiments where the external interface 28A and 28B are hard-wired connections. FIGS. 4 and 5 illustrate another embodiment of the present invention where the external interfaces are wireless connections. Here, the external interface is a short-range transmitter 28C that is capable of establishing a communication link E and F with, or at least detecting the presence of, the vehicle 20. In one embodiment, the short-range transmitter 28C may be enabled using Bluetooth™ technology. Bluetooth™ technology allows for the replacement of a wired connection by enabling devices to communicate with each other through a universal short-range radio link. A Bluetooth™ specification is available on the Internet from the Bluetooth Special Interest Group (SIG) at www.bluetooth.com, including the General Access Profile and the Hands-Free Profile of the specification. Alternatively, the short-range transmitter 28C may be enabled using infrared communications under a protocol established by the Infrared Data Association (IrDA). The specification for one type of infrared communications is available on the Internet at www.irda.org.

In one embodiment, the microcomputer 40 is connected to the short-range transmitter 28C. The microcomputer 40 is programmed with a monitoring function (vehicle detector 50) that has the capability of detecting that a wireless connection has been established between the portable wireless communication device 22 and the vehicle 20. Accordingly, the mechanism here uses the additional short-range transceiver 28C to detect whether the portable wireless communication device 22 is connected to the vehicle 20. If the portable wireless communication device 22 is wirelessly connected to the vehicle 20, then the device 22 may be configured or otherwise programmed to automatically send a message to a wireless network associated with the device 22 (via cellular transceiver 42) and insist that all subsequent incoming calls be forwarded to the vehicle's embedded transceiver 64. When the portable wireless communication device 22 determines that it has been disconnected with the vehicle 20, the device 22 may then be configured or otherwise programmed to automatically send a second message to the wireless network to cancel the forwarding of incoming calls.

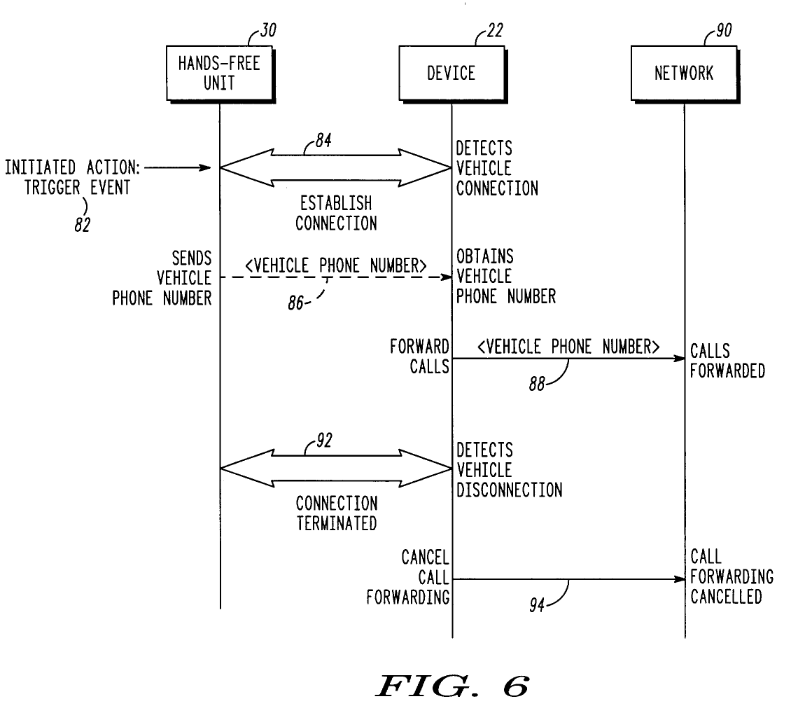

One embodiment of a process flow for forwarding calls based on the existence of a wireless connection is illustrated in FIG. 6. As shown in FIG. 6, in one embodiment, the process could be initiated based on a triggering event 82 that may occur at the hands-free control unit 30 in the vehicle 20. The triggering event 82 would then initiate a process to establish a wireless connection 84 between the portable wireless communication device 22 and the vehicle 20. For instance, if Bluetooth™ technology is used, after the initiation of the triggering event 82, the hands-free control unit 30 could act as a paging device or initiator for establishing a wireless connection 84 as specified in the Generic Access Profile of the Bluetooth Specification Version 1.1. The portable wireless communication device 22 could then serve as the paged device or acceptor. The triggering event 82 could be based on the user being physically located in the cabin of the vehicle 20. For instance, the triggering event 82 could be the user starting the ignition on of the vehicle 20. The triggering event 82 could also be a call set-up button on the user interface 76 of the vehicle 20.

The portable wireless communication device 22 is configured to detect the wireless connection with the vehicle 20. Once a wireless connection 84 has been established, in one embodiment, the portable wireless communication device 22 may obtain from the vehicle, over transmission 86, the phone number for establishing a wireless connection with the vehicle's embedded transceiver 64. In another embodiment, the portable wireless communication device 22 may obtain the phone number from its own memory 48. The microcomputer 40 of the device 22 is then programmed to forward incoming calls, originally directed to the portable wireless communication device, to the vehicle's embedded transceiver 64. The microcomputer 40 could forward calls by sending a transmission 88 to a network 90 associated with the device 22 that includes a call forward command and the forwarding phone number. The network 90 would then forward all subsequent incoming calls, originally directed to the portable wireless communication device 22, to the vehicle's embedded transceiver 64.

The portable wireless communication device 22 may further include a function to monitor whether the wireless connection terminated 92. If the connection terminated 92, then the microcomputer 40 of the device 22 would be programmed to cancel the forwarding of incoming calls. The microcomputer 40 could cancel the forwarding of calls by sending a transmission 94 to the network 90 associated with the device 22 that includes a command to cancel the forwarding of calls. The network 90 would then cancel the forwarding of incoming calls. Any incoming calls would be routed by the network 90 directly to the portable wireless communication device 22.

In another embodiment, the short-range transceiver 28C in the portable wireless communication device 22 is configured to have a very limited predetermined range for establishing the wireless connection with the vehicle 20. The predetermined range could be set to ensure that the device 22 is located adjacent or within the cabin of the vehicle 20. The benefit of this design is that no triggering event is needed to be configured on the vehicle side.

In a further embodiment, a positioning unit 78 in the vehicle 20 provides positioning information to the hands-free control unit 30. The positioning unit 78 could be a Global Positioning System (GPS) unit. The positioning information would include the position of the vehicle 20. The hands-free control unit 30 then broadcasts that positioning information to the portable wireless communication device 22 over the wireless communication link F. The vehicle detector 50 in the device 22 receives the positioning information through the short-range transceiver 28C in the device 22. In this embodiment, the portable wireless communication device 22 has its own positioning unit 80. The vehicle detector 50 would then receive the position of the vehicle 20 through the short-range transceiver 28C and it would receive the position of the device 22 through the positioning unit 80. The vehicle detector 50 would then use the positioning information to determine whether the device 22 is within a predetermined distance of the vehicle 20. The distance should be selected such that the portable wireless communication device 22 is adjacent or within the vehicle 20. The microcomputer 40 would then be programmed to forward incoming calls to the vehicle transceiver 64 when the portable wireless communication device 22 is within the predetermined distance of the vehicle 20.

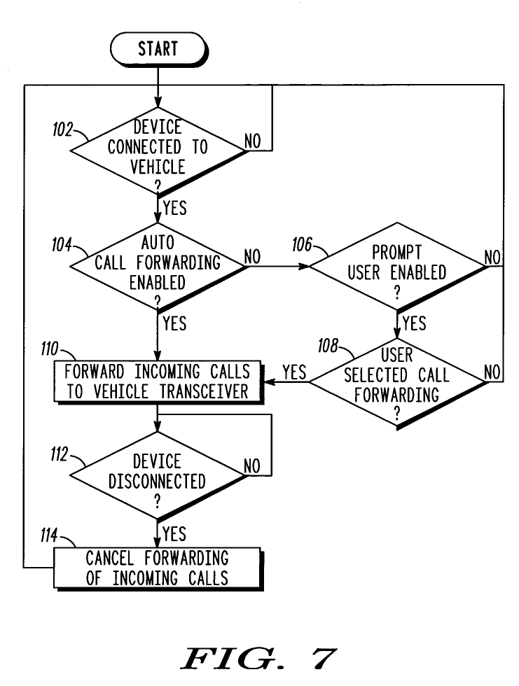

As mentioned above, in one embodiment, the portable wireless communication device 22 includes a microcomputer 40 having a processor that implements software stored in the memory 48. FIG. 7 illustrates one embodiment of a method according to the present invention. The method begins at decision block 102 where a determination is made whether the portable wireless communication device 22 is connected to the vehicle 20. This determination may be done by determining whether a wired connection exists (FIGS. 1-3) or a wireless connection exists (FIGS. 4 and 5). This step may be done through a vehicle detector 50 as explained in more detail above. If the portable wireless communication device 22 is not connected to the vehicle 20, then the process starts over and continues to repeat until a connection is detected. If a determination is made that the portable wireless communication device 22 is connected to the vehicle 20, then the process continues to decision block 104.

At decision block 104, a determination may be made by the portable wireless communication device 22 of whether the user has previously selected an option in the user interface 44 to enable the automatic forwarding of calls when the device 22 is connected to the vehicle 20. This determination step is attractive to those users who may not wish to have all incoming calls forwarded to their hands-free system. If there is a determination that the user has selected the option of automatically forwarding incoming calls to the vehicle transceiver 64, then the process proceeds to block 110. Otherwise, if it is determined that the user has not enabled automatic call forwarding, the process continues to decision block 106.

At decision block 106, a determination may be made by the portable wireless communication device 22 of whether the user has previously selected an option in the user interface 44 to enable the user to be prompted on whether to forward an incoming call. If it is determined that the user has not enabled an option of prompting the user to forward calls, then the process may end or return back to the beginning of the method. If a determination is made that the user has enabled an option of prompting the user on whether to forward calls, then the process proceeds to determination block 108.

At decision block 108, a determination is then made whether the user wants an incoming call to be forwarded to the vehicle transceiver 64. If it is determined that the user does not want to forward the call, then the process may end or return back to the beginning of the method. If a determination is made that the user does want to forward the call, then the process proceeds to block 110.

In block 110, the process includes a step of forwarding incoming calls to the vehicle transceiver 64. In one embodiment, this can be done by sending a first message to a network associated with the portable wireless communication device 22. The first message would include an instruction to forward incoming calls and data regarding the phone number that the calls should be forwarded. The process then proceeds to decision block 112.

At decision block 112, there is a determination whether the portable wireless communication device 22 becomes disconnected to the vehicle 20. If there is no disconnection, the process waits at this block until there is a disconnection. Once there is a disconnection between the device 22 and the vehicle 20, then the process may proceed to block 114.

In block 114, the process includes a step of canceling the forwarding of incoming calls to the vehicle transceiver 64. In one embodiment, this can be done by sending a second message to the network associated with the portable wireless communication device 22. The second message would include an instruction to cancel the forwarding of future incoming calls. Now, future incoming calls would go directly to the portable wireless communication device 22.

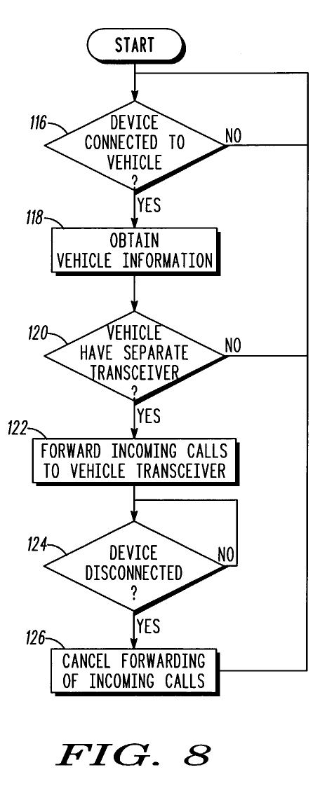

FIG. 8 illustrates a further embodiment of a method that may be implemented by using the present invention. This method, however, uses information obtained from the vehicle including an identification of whether the vehicle has a separate cellular transceiver 64 within the vehicle 20 and data regarding the operation of the vehicle transceiver 64. The data regarding the operation of the vehicle could include a phone number that is associated with establishing a wireless communication link with the vehicle transceiver 64.

The method may start at decision block 116 where a determination is made whether the portable wireless communication device 22 is connected to the vehicle 20. This could include determining whether the device 22 is connected to the hands-free control unit 30, whether wired or wireless. This could be done through the use of the vehicle detector 50 in the device 22, as discussed in more detail above. If the device 22 is not connected to the vehicle 20, then the process will stay at the decision block 116 until a determination is made that the device 22 is connected to the vehicle 20. When a determination is made that the device 22 is connected to the vehicle 20, then the process continues to block 118.

At block 118, the process may include a step of obtaining vehicle information from the vehicle 20. Here, the device 22 may obtain data, such as whether the vehicle 20 contains its own cellular transceiver 64 and, if so, data associated with communicating with the transceiver 64. This could be done by having the device 22 obtain or access information from the hands-free control unit 30 through external interfaces such as the external communication interface 28B or the wireless external interface 28C. Alternatively, the device could obtain data from its own memory that was previously obtained or entered into the device 22. The process then proceeds to decision block 120.

At decision block 120, a determination is made whether the vehicle includes a separate transceiver 64. This could be accomplished by looking at the vehicle information obtained at process block 118. If the vehicle 20 does not have a separate transceiver 64, the process essentially ends and no calls are forwarded. If the vehicle 20 does contain a separate transceiver 64, then the process continues to block 122 where the device 22 configures the forwarding of incoming calls to the vehicle transceiver 64. This could include notifying the cellular network by a message to forward incoming calls to a number of the vehicle's embedded cellular transceiver 50. The data for forwarding the call may be accessed from the vehicle information obtained in process block 118. The process may then proceed to decision block 124.

At decision block 124, a determination is made whether the portable wireless communication device 22 has been disconnected from the vehicle 20. If there is still a connection, then the process will stay at decision block 124 until there is a disconnection. When it is detected that the device 22 is no longer connected to the vehicle 20, then the process may proceed to block 126 where the forwarding of calls to the vehicle transceiver 64 are cancelled. This could be accomplished by sending a second message to the network associated with the device 22 to cancel the forwarding of any future incoming calls. Accordingly, incoming calls would then be put direction through to the portable wireless communication device 22. After block 126, the process may end or return back to the beginning of the method.

What has been described is a system and method for forwarding calls to a vehicle's embedded transceiver when a user enters the vehicle with a separate portable wireless communication device. The system and method reduces the complexity and the number of distractions when answering or establishing a cellular communication. The above description of the present invention is intended to be exemplary only and is not intended to limit the scope of any patent issuing from this application. The present invention is intended to be limited only by the scope and spirit of the following claims.

What is claimed is:

1. A portable wireless communication device comprising:
a cellular transceiver; and
a microcomputer having a detector to determine whether the portable wireless communication device is connected to a vehicle;
wherein the microcomputer is programmed to forward an incoming call, originally directed to the portable wireless communication device, to a vehicle transceiver within the vehicle when the detector determines that the portable wireless communication device is connected to the vehicle.

2. The portable wireless communication device in claim 1 further comprising an external interface, wherein the detector is capable of monitoring the external interface to determine whether the external interface is connected to the vehicle.

3. The portable wireless communication device in claim 2, wherein the external interface is capable of being connected to an external cord that extends between the portable wireless communication device and the vehicle, the external cord having at least one communication line that is used by the detector to determine whether the portable wireless communication device is connected to the vehicle.

4. The portable wireless communication device in claim 2, wherein the external interface is capable of being connected to a device docking station mounted in the vehicle.

5. The portable wireless communication device in claim 4, wherein the device docking station is connected to a hands-free control unit in the vehicle, the microcomputer capable of obtaining information from the hands-free control unit after it is determined that the portable wireless communication device is connected to the vehicle, the information comprising of data associated with establishing a communication link with the vehicle transceiver.

6. The portable wireless communication device in claim 1 further comprising a short-range transceiver that is capable of establishing a wireless connection with the vehicle.

7. The portable wireless communication device in claim 6, wherein the wireless connection is not established between the portable wireless communication device and the vehicle until a triggering event occurs in the vehicle.

8. The portable wireless communication device in claim 6, wherein the short-range transceiver has a limited predetermined range for establishing the wireless connection with the vehicle.

9. The portable wireless communication device in claim 1, wherein the programming of the microcomputer to forward the incoming call includes sending a message to a network associated with the portable wireless communication device, the message including a telephone number of the vehicle transceiver.

10. A system for forwarding incoming calls, originally directed to a portable wireless communication device, to a vehicle transceiver in a vehicle, the system comprising:
a cellular transceiver in the portable wireless communication device;
an external interface in the portable wireless communication device for connecting to the vehicle; and
a microcomputer in the portable wireless communication device connected to the external interface to determine whether the portable wireless communication device is connected to the vehicle, the microcomputer being programmed to forward the incoming calls to the vehicle transceiver when it is determined that the portable wireless communication device is connected to the vehicle.

11. The system in claim 10, wherein the external interface is capable of being connected to an external cord that extends between the portable wireless communication device and the vehicle, the external cord having at least one communication line that is used by the microcomputer to determine whether the portable wireless communication device is connected to the vehicle.

12. The system in claim 10, wherein the external interface is capable of being connected to a device docking station mounted in the vehicle.

13. The system in claim 12, wherein the device docking station is connected to a hands-free control unit in the vehicle, the microcomputer capable of obtaining information from the hands-free control unit after it is determined that the portable wireless communication device is connected to the vehicle, the information comprising of data associated with establishing a communication link with the vehicle transceiver.

14. The system in claim 10, wherein the external interface is a short-range transceiver that is capable of establishing a wireless communication link with the vehicle.

15. The system in claim 14, wherein the wireless connection is not established between the portable wireless communication device and the vehicle until a triggering event occurs in the vehicle.

16. The system in claim 10, wherein the programming of the microcomputer to forward the incoming calls includes sending a message to a network associated with the portable wireless communication device, the message including a telephone number of the vehicle transceiver.

17. The system in claim 16, wherein the programming of the microcomputer to forward the incoming calls includes sending a second message to the network associated with the portable wireless communication device when the microcomputer determines that the portable wireless communication device has been disconnected from the vehicle, the second message canceling the forwarding of incoming calls to the vehicle transceiver.

18. A method in a portable wireless communication device, the method comprising the steps of:
determining whether the portable wireless communication device is connected to a vehicle; and
sending a message to a network associated with the portable wireless communication device when it is determined that the portable wireless communication device is connected to the vehicle, the message containing data to forward incoming calls, originally directed to the portable wireless communication device, to a transceiver in the vehicle.

19. The method in claim 18 further comprises the steps of:
determining whether the portable wireless communication device becomes disconnected to the vehicle; and
sending a second message to the network associated with the portable wireless communication device when it is determined that the portable wireless communication device becomes disconnected to the vehicle, the second message containing data to cancel the forwarding of incoming calls.

20. The method in claim 18, wherein the data in the message includes at least a telephone number for establishing a communication link with the transceiver of the vehicle.

21. The method in claim 18, wherein the step of determining whether the portable wireless communication device is connected to the vehicle includes monitoring an external interface in the portable wireless communication device to determine whether the device is connected to the vehicle.

22. The method in claim 18, wherein the step of determining whether the portable wireless communication device is connected to the vehicle includes monitoring a short-range transceiver in the portable wireless communication device.

23. The method in claim 18, wherein before the step of sending the message to the network, the method further comprises the step of obtaining information from the vehicle that includes data associated with establishing a communication link with the vehicle transceiver.
